(19) United States
(12) Patent Application Publication
(10) Pub. No.: US 2005/0118305 A1
(43) Pub. Date: Jun. 2, 2005

(54) Mexican style pizza

(76) Inventor: Christopher Romero, Modesto, CA (US)

Correspondence Address: JAMES RAY & ASSOCIATES, 2640 PITCAIRN ROAD, MONROEVILLE, PA, 15146, US

(21) Appl. No.: 11/001,162

(22) Filed: Dec. 1, 2004

Related U.S. Application Data
(60) Provisional application No. 60/526,226, filed on Dec. 2, 2003.

(51) Int. Cl. A23G 3/00

(52) U.S. Cl. 426/94

(57) ABSTRACT

A method of making a pizza which includes the method of making the crust for the pizza which includes tortilla flour in the recipe for the crust. Such pizza further includes the method of making a sauce which contains tomatillos, green chili peppers and enchilada sauce in the preparation of the sauce. The pizza also includes a combination of blended Mexican cheeses as topping for the pizza.

### CROSS REFERENCE TO RELATED APPLICATIONS

This application is closely related to and claims benefit from U.S. Provisional Application Ser. No. 60/526,226 filed Dec. 02, 2003.

### FIELD OF THE INVENTION

The present invention relates, in general, to a pizza, and, more particularly, the present invention relates to a recipe and a method of making a Mexican style pizza.

### BACKGROUND OF THE INVENTION

Presently, pizzas are one of the most widely consumed fast foods in the country today, and their popularity seems to be growing every year. Pizza parlors are so prevalent that there are few areas where there isn't at least one pizza shop in the neighborhood and, generally, there are several. Each pizza shop has its own recipe and its own method of making the pizza. Many of the chain pizza shops provide a variety of crusts which are available as well different varieties of toppings. However, most of the chain pizza shops use their own recipe for their sauce in all of their chains. The sauce recipe is generally generic and one which the chains use for virtually all of their pizzas.

### SUMMARY OF THE INVENTION

The present invention, in one embodiment, provides a method of making a pizza crust for use in making a Mexican style pizza. The method comprises the steps of determining a size and a shape of a pizza to be made. Another step provides for heating water to between about 105° F. and about 115° F. and placing a predetermined amount of the water heated in a previous step into a first vessel based on the size of the pizza to be made as previously determined. A predetermined amount of yeast is dissolved in the water. Other steps involve determining an amount of all purpose flour to be used, determining an amount of tortilla flour to be used and determining an amount of salt to be used based on the size of the pizza to be made that was previously determined. Another step involves combining the all purpose flour, the tortilla flour with the salt in a second vessel. There is a step of adding the all purpose flour, the tortilla flour and the salt combined previously along with a predetermined amount of vegetable oil to the yeast that was dissolved in the water in a previous step along with the step of stirring this mixture thoroughly. There is a step of placing the dough mixture obtained by stirring previously onto a lightly floured board. The dough mixture is kneaded and placed on a lightly floured board until the dough mixture is smooth and elastic. Other steps involve greasing lightly a third vessel for holding the dough mixture kneaded previously, placing the dough mixture into a third vessel greased in a previous step and turning the dough mixture placed in the third vessel to ensure that grease is deposited on the top portion of the dough mixture. The dough mixture is covered and allowed to rise a predetermined amount. The dough mixture that was allowed to rise is punched down. The dough mixture is rolled out to the size and shape of the pizza that was determined previously. There is a step of placing the dough mixture that was rolled out onto one of a pizza pan or a cooking sheet and brushing the dough mixture lightly with oil. The dough mixture is allowed to rise for a predetermined time after it had been brushed with oil. The dough mixture, after rising, is pricked with a predetermined instrument. There is a step of preheating the oven to about 400° F. and placing the dough mixture pricked in a previous step into the preheated oven and baking the dough mixture for a predetermined time. Another step includes removing the baked pizza crust from the oven.

In another embodiment of the invention there is a method of making a pizza sauce for use in making a Mexican style pizza. The method comprises the steps of determining a size and a shape of a pizza to be made, determining a first amount of olive oil required for the pizza sauce based on the size and shape of the pizza determined previously and pouring the olive oil into a first vessel and heating the first amount of olive oil. There is a step of adding a predetermined amount of onion, garlic, tomatillos and green chili peppers to the olive oil heated previously and a step of sautéing the predetermined amount of onion, garlic, tomatillos and green chili peppers added to oil previously for a first predetermined time and over a predetermined heat while stirring constantly. A predetermined amount of enchilada sauce is added to the first vessel after heating for such first predetermined time.

There is a step of adding a predetermined amount of water to the first vessel after such first predetermined time and adding a predetermined amount of preselected seasonings to the first vessel after such first predetermined time and bringing the mixture obtained in a previous step to a boil and thereafter reducing heat to low. The mixture is cooked uncovered in the first vessel for a second predetermined time while stirring such mixture occasionally.

A roux is prepared by sautéing a predetermined amount of flour mixed with a second predetermined amount of olive oil in a second vessel.

The mixture that was cooked uncovered in the first vessel is brought to a boil for a second time. The roux is then added to the mixture. There is the step of boiling the mixture, including the roux, for a third predetermined time which is at least sufficient to thicken the mixture. The mixture is stirred occasionally while boiling and then the mixture is set aside for cooling.

In another aspect of the invention there is provided a method for making a Mexican style pizza. The method comprises the steps of determining a size and a shape of a pizza to be made, providing a crust containing a predetermined volume of tortilla flour and having said size and said shape determined previously and which has been at least partially baked and placing such crust provided into a pizza baking pan. There is a step of covering at least a portion of the crust provided previously with a pizza sauce containing a predetermined amount of olive oil, onions, garlic, tomatillos, green chili peppers, enchilada sauce, water and certain other preselected seasonings. Such pizza sauce is then covered with a mixture of cheeses containing Monterey Jack, cheddar, queso quesadilla and asadero. There is a step of baking the pizza in a preheated oven for a predetermined time which is at least sufficient to melt the mixture of cheeses and removing the pizza from the oven after baking and removing the pizza from the pizza baking pan, cutting such pizza and serving the pizza.

### OBJECTS OF THE INVENTION

It is, therefore, one of the primary objects of the present invention to provide a pizza which is prepared in a Mexican style and taste.

Another object of the present invention to provide a pizza which contains tortilla flour in the preparation of the crust.

Still another object of the present invention to provide a pizza which includes green chili peppers and enchilada sauce in the preparation of the pizza sauce.

Yet another object of the present invention to provide a pizza which includes a mixture of blended Mexican cheeses for the topping.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE PRESENTLY PREFERRED AND VARIOUS ALTERNATIVE EMBODIMENTS OF THE INVENTION

The present invention, in one embodiment, provides a method of making a pizza crust for use in making a Mexican style pizza. The method comprises the steps of determining a size and a shape of a pizza to be made. The size of such pizza is determined by the person doing the baking; however, for the purpose of providing a reference point for the ingredients all the following amounts will be directed to making a pizza which is approximately 12 inches in diameter. For different size pizzas the amounts can be altered to adjust for the different size.

The method provides for heating water to between about 105° F. and about 115° F. and placing a predetermined amount of the heated water into a first vessel. The amount of water is based on the size of the pizza to be made. It is preferred that such water is between about 7/16 cup and about 9/16 cup. In a most preferred embodiment of the invention such water is ½ cup. A predetermined amount of yeast is dissolved in the water. It is preferred that about 1 package of active dry yeast be used. Since the dry yeast comes a package it is difficult to vary the amount.

Other steps involve determining an amount of all purpose flour to be used, determining an amount of tortilla flour to be used and determining an amount of salt to be used. Again based on a 12 inch pizza it is preferred that between about ⅝ cup and about ⅞ cup of such tortilla flour and such all purpose flour be added, while between about ⅜ and ⅝ teaspoon of salt is added . In the most preferred embodiment ¾ cup of each flour is added and ½ teaspoon of salt.

Another step involves combining the all purpose flour, the tortilla flour with the salt in a second vessel. The combined salt and flour mixture is further combined with vegetable oil and the mixture added to the yeast that was dissolved in the water in a previous step. It is preferred that approximately 1 teaspoon of such oil be added. The mixture is stirred thoroughly. There is a step of placing the dough mixture obtained by stirring previously onto a lightly floured board. The dough mixture is kneaded and placed on a lightly floured board until the dough mixture is smooth and elastic. Other steps involve greasing lightly a third vessel for holding the dough mixture kneaded previously, placing the dough mixture into a third vessel greased in a previous step and turning the dough mixture placed in the third vessel to ensure that grease is deposited on the top portion of the dough mixture. The dough mixture is covered and allowed to rise till the mixture is about double in size. This usually takes about 1½ hours. The dough mixture is then punched down. The dough mixture is rolled out to the size and shape of the pizza that was determined previously. In this case it is approximately 12 inches. There is next a step of placing the dough mixture that was rolled out onto one of a pizza pan or a cooking sheet and brushing the dough mixture lightly with oil. The dough mixture is allowed to rise for a predetermined time after it had been brushed with oil. The dough mixture, after rising, is pricked with a predetermined instrument. The dough mixture is allowed to rise for approximately 10 minutes. The oven is preheated to about 400° F. and the dough mixture pricked in a previous step and placed on a pan is placed into the preheated oven. The dough mixture is heated for a predetermined time. It is preferred that such predetermined time be approximately 10 minutes. The baked pizza crust is removed from the oven.

In another embodiment of the invention there is a method of making a pizza sauce for use in making a Mexican style pizza. The method comprises the steps of determining a size and a shape of a pizza to be made. Again all of the amounts for all of the ingredients will be based on making a 12 inch pizza. A first amount of olive oil required for the pizza sauce is determined based on the size and shape of the pizza selected. It is presently preferred that such first amount of olive oil be between about ⅞ and about 1⅛ tablespoon. The measured olive oil is poured into a first vessel and the oil is heated. There is a step of adding a predetermined amount of onion, garlic, tomatillos and green chili peppers to the olive oil heated previously and a step of sautéing the predetermined amount of onion, garlic, tomatillos and green chili peppers added to oil for a first predetermined time and over a predetermined heat while stirring constantly. It is preferred that the predetermined amount of onion is between about 3/16 and about 5/16 cup of chopped onion, the predetermined amount of garlic is about 2 cloves of minced garlic, the predetermined amount of tomatillos is between about 5 and about 7 sliced tomatillos and predetermined amount of green chili peppers is about a 7 ounce can of whole green chili peppers.

A predetermined amount of enchilada sauce is added to the first vessel after the ingredients had been sautéed for about 5 minutes with constant stirring. Such predetermined amount of enchilada sauce is about a 28 ounce can of red enchilada sauce. A predetermined amount of water and a predetermined amount of seasonings are added to the mixture with the enchilada sauce added. The mixture in the first vessel is brought to a boil and thereafter the heat is reduced to low. The mixture is cooked uncovered in the first vessel for a second predetermined time while stirring such mixture occasionally. Such second predetermined time is approximately 50 minutes. It is preferred that the predetermined amount of water added to the first vessel is between about 12 ounces and about 16 ounces and that such predetermined amount of the preselected seasonings include between about ⅜ and about ⅝ teaspoon of sage, between about ⅜ and about ⅝ teaspoon of oregano, between about 1/16 and about 3/16 teaspoon of freshly ground pepper and between about ⅜ and about ⅝ teaspoon of salt. A roux is prepared in a second vessel in which approximately ¼ cup of flour is mixed with approximately 2 tablespoons of olive oil. The mixture is then sautéed. The mixture cooked uncovered is brought to a boil for a second time. The roux is then added to the mixture. There is the step of boiling the mixture, including the roux, for a third predetermined time which is at least sufficient to thicken the mixture. The mixture is stirred occasionally while boiling and then the mixture is set aside for cooling.

In another aspect of the invention there is provided a method for making a Mexican style pizza. The method comprises the steps of determining a size and a shape of a pizza to be made, providing a crust containing a predetermined volume of tortilla flour and having said size and said shape determined previously and which has been at least partially baked and placing such crust provided into a pizza baking pan. There is a step of covering at a portion of the crust provided previously with a pizza sauce containing a predetermined amount of olive oil, onions, garlic, tomatillos, green chili peppers, enchilada sauce, water and certain other preselected seasonings. Such pizza sauce is then covered with a mixture of cheeses containing Monterey Jack, cheddar, queso quesadilla and asadero. There is a step of baking the pizza in a preheated oven for a predetermined time which is at least sufficient to melt the mixture of cheeses and removing the pizza from the oven after baking and removing the pizza from the pizza baking pan, cutting such pizza and serving the pizza.

In summarizing the present invention, the following provides a recipe for making a pizza that is approximately 12 inches in diameter. It must be remembered that the amounts can vary somewhat from those listed and still be within the scope of the invention. In the case where a can of material is used it is difficult to vary the amount for a 12 inch pizza, however, if the can has a slightly different content it would still be within the scope of the invention.

Pizza Crust & Pizza

1 package active dry yeast
½ cup warm water (105-115° F.)
¾ cup all purpose flour
¾ cup tortilla flour
½ tsp. Salt p0 1 tsp. Vegetable oil

Dissolve yeast in warm water in a medium bowl. Combine flours and salt in a separate bowl. Add flour mixture and oil to the yeast; stir well. Turn out onto a lightly floured board; knead until smooth and elastic, about 6 to 8 minutes. Lightly grease bowl. Place dough in bowl; turn once to grease the top surface. Cover; let it rise until double in bulk, about 1½ hours. (Prepare sauce while the dough is rising). When the dough has doubled, punch down. Roll out into a 12 inch circle; place on a round pizza pan or cookie sheet. Brush lightly with oil. Let rise 10 minutes, then prick with a fork. Bake 10 minutes in preheated 400° F. oven. If necessary fork any areas that rise too fast. (Prepare topping while crust is baking.) Remove crust from oven. Top with sauce, 1 cup cheese and desired toppings. Bake 12 minutes or until cheese is melted and lightly browned. Remove pizza from the pan; cut and serve. Yields a 12 inch pizza.

Pizza Sauce

1 tablespoon olive oil
¼ cup chopped onion
2 cloves garlic (minced)
½ tsp. Salt
⅛ tsp. Freshly ground black pepper
½ tsp. Sage
½ tsp. Oregano
6 tomatillos (sliced)
1 can (7 oz.) Whole green chili peppers
1 can (28 oz.) Las Palmas red enchilada sauce (mild)
14 oz. Water
   Roux
¼ cup flour
2 tablespoons olive oil (sauté)
   To Prepare The Sauce:

Heat oil in medium sauce pan, Add onion, garlic, tomatillos, and the green chili peppers; sauté over medium heat for 5 minutes, stirring constantly. Do not brown! Add enchilada sauce, water seasonings and sauté mixture in a sauce pan. Bring to a boil; reduce heat to low. Cook, uncovered, stirring occasionally, for 50 minutes. Then bring to a boil, add roux, and stir occasionally for 10 minutes or until thick. Set aside to cool.

Pizza Toppings

1 stick 7 oz. Chorizo (remove casing, brown, drain half of the liquid and add to hamburger mixture.)
1 pound ground beef (drained and browned).
1 (4½ oz.) Sliced black olives
1 cup Mexican Blended Cheeses (Monterey Jack, cheddar, queso quesadilla and asadero).

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. A method of making a pizza crust for use in making a Mexican style pizza, said method comprising the steps of:
(a) determining a size and a shape of a pizza to be made;
(b) heating water to between about 105° F. and about 115° F.;
(c) placing a predetermined amount of water heated in step (b) into a first vessel based on said size of said pizza to be made determined in step (a);
(d) dissolving a predetermined amount of yeast in said water based on said size of said pizza to be made determined in step (a);
(e) determining an amount of all purpose flour to be used based on said size of said pizza to be made determined in step (a);
(f) determining an amount of tortilla flour to be used based on said size of said pizza to be made determined in step (a);
(g) determining an amount of salt to be used based on said size of said pizza to be made determined in step (a);
(h) combining said all purpose flour determined in step (e) and said tortilla flour determined in step (f) with said salt determined in step (g) in a second vessel;
(i) adding said all purpose flour and said tortilla flour and said salt combined in step (h) along with a predetermined amount of vegetable oil based on said size of said pizza to be made determined in step (a) to said yeast dissolved in said water in step (d);
(j) stirring well;
(k) placing dough mixture obtained by stirring in step (j) onto a lightly floured board;
(l) kneading said dough mixture placed on said lightly floured board in step (k) until said dough mixture is smooth and elastic;
(m) greasing lightly a third vessel for holding said dough mixture kneaded in step (l);
(n) placing said dough mixture kneaded in step (l) into said third vessel greased in step (m);
(o) turning said dough mixture placed in said third vessel in step (n) to ensure grease is deposited on top portion of said dough mixture;
(p) covering said dough mixture turned in step (o) and allowing to rise a predetermined amount;
(q) punching said dough mixture, allowed to rise in step (p), down;
(r) rolling out said dough mixture to said size and said shape of said pizza to be made determined in step (a);
(s) placing said dough mixture rolled out in step (r) onto one of a pizza pan and a cooking sheet;
(t) brushing said dough mixture placed on said one of said pizza pan and said cooking sheet in step (s) lightly with oil;
(u) allowing said dough mixture to rise for a predetermined time after brushing with said oil in step (t);
(v) pricking said dough mixture allowed to rise in step (u) with a predetermined instrument;
(w) preheating oven to about 400° F.;
(x) placing said dough mixture pricked in step (v) into said oven preheated in step (w);
(y) baking said dough mixture for a predetermined time; and
(z) removing said pizza crust baked in step (y) from oven.

2. The method of making a pizza crust, according to claim 1, wherein said pizza is generally round and having substantially a 12 inch diameter.

3. The method of making a pizza crust, according to claim 2, wherein said predetermined amount of water used to make a substantially 12 inch pizza is between about 7/16 cup and about 9/16 cup.

4. The method of making a pizza crust, according to claim 2, wherein said predetermined amount of yeast for a substantially 12 inch pizza is about one package of dry active yeast.

5. The method of making a pizza crust, according to claim 2, wherein said predetermined amount of all purpose flour and said predetermined amount of tortilla flour is between about ⅝ cup and about ⅞ cup of each.

6. The method of making a pizza crust, according to claim 2, wherein said predetermined amount of salt is between about ⅜ and about ⅝ teaspoon.

7. The method of making a pizza crust, according to claim 2, wherein said predetermined amount of vegetable oil is between about ⅜ and about ⅝ teaspoon.

8. A method of making a pizza sauce for use in making a Mexican style pizza, said method comprising the steps of:
(a) determining a size and a shape of a pizza to be made;
(b) determining a first amount of olive oil required for said pizza sauce based on said size and said shape of said pizza determined in step (a) and pour into a first vessel;
(c) heating said first amount of olive oil determined in step (b);
(d) adding a predetermined amount of onion, garlic, tomatillos and green chili peppers to said olive oil heated in step (c);
(e) sautéing said predetermined amount of said onion, said garlic, said tomatillos and said green chili peppers added to said oil in step (d) for a first predetermined time and over a predetermined heat;
(f) stirring constantly said predetermined amount of said chopped onion, said garlic, said tomatillos and said green chili peppers being sautéed in said olive oil in step (e);
(g) adding a predetermined amount of enchilada sauce to said first vessel after said first predetermined time;
(h) adding a predetermined amount of water to said first vessel after said first predetermined time;
(i) adding a predetermined amount of preselected seasonings to said first vessel after said first predetermined time;
(j) bringing mixture obtained in step (i) to a boil and thereafter reducing heat to low;
(k) cooking said mixture uncovered in said first vessel for a second predetermined time;
(l) stirring said mixture occasionally while cooking in step (k);
(m) preparing a roux by sautéing a predetermined amount of flour mixed with a second predetermined amount of olive oil in a second vessel;
(n) bringing mixture to a boil for a second time;
(o) adding said roux prepared in steps (m) and (n) predetermined amount of flour mixed with said second predetermined amount of olive oil] in said second vessel to said mixture;
(p) boiling said mixture obtained in step (o) for a third predetermined time which is at least sufficient to thicken said mixture;
(q) stirring said mixture occasionally while boiling in step (p); and
(r) setting said mixture aside for cooling after said third predetermined time.

9. The method of making a pizza sauce, according to claim 8, wherein said pizza is generally round and having substantially a 12 inch diameter.

10. The method of making a pizza sauce, according to claim 9, wherein said first amount of said olive oil is between about ⅞ and about 1⅛ tablespoon.

11. The method of making a pizza sauce, according to claim 9, wherein said predetermined amount of onion is between about 3/16 and about 5/16 cup of chopped onion, said predetermined amount of said garlic is about 2 cloves of minced garlic, said predetermined amount of said tomatillos is between about 5 and about 7 sliced tomatillos and said predetermined amount of said green chili peppers is about a 7 ounce can of whole green chili peppers.

12. The method of making a pizza sauce, according to claim 9, wherein said predetermined amount of said enchilada sauce is about a 28 ounce can of red enchilada sauce.

13. The method of making a pizza sauce, according to claim 9, wherein said predetermined amount of said preselected seasonings include between about ⅜ and about ⅝ teaspoon of sage, between about ⅜ and about ⅝ teaspoon of oregano, between about 1/16 and about 3/16 teaspoon of freshly ground pepper and between about ⅜ and about ⅝ teaspoon of salt.

14. The method of making a pizza sauce, according to claim 9, wherein said predetermined amount of flour used to prepare said roux is between about 3/16 and about 5/16 cup.

15. The method of making a pizza sauce, according to claim 9, wherein said second predetermined amount of olive oil used to prepare said roux is between about 1½ and about 2½ tablespoons.

16. A method of making a Mexican style pizza, said method comprising the steps of:
(a) determining a size and a shape of said pizza to be made;
(b) providing a crust containing a predetermined volume of tortilla flour and having said size and said shape determined in step (a) and which has been at least partially baked;
(c) placing said crust provided in step (b) into a pizza baking pan;
(d) covering at least a portion of said crust provided in step (b) with a pizza sauce containing a predetermined amount of olive oil, onions, garlic, tomatillos, green chili peppers, enchilada sauce, water and certain other preselected seasonings;
(e) covering said pizza sauce with a mixture of cheeses containing Monterey Jack, cheddar, queso quesadilla and asadero;
(f) baking said pizza in a preheated oven for a predetermined time which is at least sufficient to melt said mixture of cheeses;
(g) removing said pizza from said oven after baking in step (f); and
(h) removing pizza from pizza baking pan, cut and serve.

17. The method of making a Mexican style pizza, according to claim 16, wherein said shape of said pizza is generally round and having substantially a 12 inch diameter.

18. The method of making a Mexican style pizza, according to claim 17, wherein said crust is prepared by a method comprising the steps of:
(a) determining a size and a shape of a pizza to be made;
(b) heating water to between about 105° F. and about 115° F.;
(c) placing a predetermined amount of water heated in step (b) into a first vessel based on said size of said pizza to be made determined in step (a);
(d) dissolving a predetermined amount of yeast in said water based on said size of said pizza to be made determined in step (a);
(e) determining an amount of all purpose flour to be used based on said size of said pizza to be made determined in step (a);
(f) determining an amount of tortilla flour to be used based on said size of said pizza to be made determined in step (a);
(g) determining an amount of salt to be used based on said size of said pizza to be made determined in step (a);
(h) combining said all purpose flour determined in step (e) and said tortilla flour determined in step (f) with said salt determined in step (g) in a second vessel;
(i) adding said all purpose flour and said tortilla flour and said salt combined in step (h) along with a predetermined amount of vegetable oil based on said size of said pizza to be made determined in step (a) to said yeast dissolved in said water in step (d);
(j) stirring well;
(k) placing dough mixture obtained by stirring in step (j) onto a lightly floured board;
(l) kneading said dough mixture placed on said lightly floured board in step (k) until said dough mixture is smooth and elastic;
(m) greasing lightly a third vessel for holding said dough mixture kneaded in step (l);
(n) placing said dough mixture kneaded in step (l) into said third vessel greased in step (m);
(o) turning said dough mixture placed in said third vessel in step (n) to ensure grease is deposited on top portion of said dough mixture;
(p) covering said dough mixture turned in step (o) and allowing to rise a predetermined amount;
(q) punching said dough mixture, allowed to rise in step (p), down;
(r) rolling out said dough mixture to said size and said shape of said pizza to be made determined in step (a);
(s) placing said dough mixture rolled out in step (r) onto one of a pizza pan and a cooking sheet;
(t) brushing said dough mixture placed on said one of said pizza pan and said cooking sheet in step (s) lightly with oil;
(u) allowing said dough mixture to rise for a predetermined time after brushing with said oil in step (t);
(v) pricking said dough mixture allowed to rise in step (u) with a predetermined instrument;
(w) preheating oven to about 400° F.;
(x) placing said dough mixture pricked in step (v) into said oven preheated in step (w);
(y) baking said dough mixture for a predetermined time; and
(z) removing said pizza crust baked in step (y) from oven.

19. The method of making a Mexican style pizza, according to claim 17, wherein said pizza sauce is prepared by a method comprising the steps of:
(a) determining a size and a shape of a pizza to be made;
(b) determining a first amount of olive oil required for said pizza sauce based on said size and said shape of said pizza determined in step (a) and pour into a first vessel;
(c) heating said first amount of olive oil determined in step (b);
(d) adding a predetermined amount of onion, garlic, tomatillos and green chili peppers to said olive oil heated in step (c);
(e) sautéing said predetermined amount of said onion, said garlic, said tomatillos and said green chili peppers added to said oil in step (d) for a first predetermined time and over a predetermined heat;
(f) stirring constantly said predetermined amount of said chopped onion, said garlic, said tomatillos and said green chili peppers being sautéed in said olive oil in step (e);
(g) adding a predetermined amount of enchilada sauce to said first vessel after said first predetermined time;
(h) adding a predetermined amount of water to said first vessel after said first predetermined time;
(i) adding a predetermined amount of preselected seasonings to said first vessel after said first predetermined time;
(j) bringing mixture obtained in step (i) to a boil and thereafter reducing heat to low;
(k) cooking said mixture uncovered in said first vessel for a second predetermined time;
(l) stirring said mixture occasionally while cooking in step (k);
(m) preparing a roux by sautéing a predetermined amount of flour mixed with a second predetermined amount of olive oil in a second vessel;
(n) bringing mixture to a boil for a second time;
(o) adding said roux prepared in steps (m) and (n) predetermined amount of flour mixed with said second predetermined amount of olive oil] in said second vessel to said mixture;
(p) boiling said mixture obtained in step (o) for a third predetermined time which is at least sufficient to thicken said mixture;
(q) stirring said mixture occasionally while boiling in step (p); and
(r) setting said mixture aside for cooling after said third predetermined time.

20. The method of making a Mexican style pizza, according to claim 19, wherein said predetermined amount of various ingredients are:
(a) said predetermined amount of onion is between about 3/16 and about 5/16 cup of chopped onion;
(b) said predetermined amount of said garlic is about 2 cloves of minced garlic;
(c) said predetermined amount of said tomatillos is between about 5 and about 7 sliced tomatillos; and
(d) said predetermined amount of said green chili peppers is about a 7 ounce can of whole green chili peppers;
(e) said predetermined amount of said enchilada sauce is about a 28 ounce can of red enchilada sauce;
(f) said predetermined amount of said preselected seasonings include between about ⅜ and about ⅝ teaspoon of sage, between about ⅜ and about ⅝ teaspoon of oregano, between about 1/16 and about 3/16 teaspoon of freshly ground pepper and between about ⅜ and about ⅝ teaspoon of salt.

21. The method of making a Mexican style pizza, according to claim 16, wherein said predetermined time for baking said pizza is between about 10 and 14 minutes.
